(19) United States
(12) Patent Application Publication
(10) Pub. No.: US 2001/0054061 A1
(43) Pub. Date: Dec. 20, 2001

(54) Object supplying device

(76) Inventor: Noritaka Koyama, Tokyo (JP)

Correspondence Address: RABIN & CHAMPAGNE, PC, 1101 14TH STREET, NW, SUITE 500, WASHINGTON, DC, 20005, US

(21) Appl. No.: 09/810,446

(22) Filed: Mar. 19, 2001

(30) Foreign Application Priority Data
Jun. 3, 2000 (JP) 198420/2000

(51) Int. Cl. G06F 15/16

(52) U.S. Cl. 709/201

(57) ABSTRACT

An object supplying device to supply an object to one of a plurality of principals is provided which is made up of a principal information storing section used to store information about each of the plurality of principals and an object information storing section used to store information about each of a plurality of objects and an application section used to retrieve an object corresponding to one principal by combining a plurality of pieces of information stored in the principal information storing section with a plurality of pieces of information stored in the object information storing section and by referring to the combined information and to supply the retrieved object to the one principal.

### BACKGROUND OF THE INVENTION

1. Field of the Invention

The present invention relates to an object supplying device to supply an object to a principal in a processing system such as a distributed processing device using a network.

2. Description of the Related Art

Conventionally, to maintain security of the distributed processing system, validation and authentication of a principal is performed. The principal represents a principal and individual entity such as a client unit, a user operating the client unit, an object included in the client unit and a portable communication terminal in a portable communication system used as the distributed processing system. As a method for controlling on an access by an authorized principal to the object, for example, an access control list can be used. The access control list contains the object to which the principal accesses, processing of the object (for example, reading, writing, execution of the object or a like) and permission to execute the processing of the object.

However, the conventional object supplying device is adapted to only control the access by the principal in accordance with contents of the above access control list. In the conventional object supplying device, since the object on which the access control is executed, the processing of the object and the permission of the processing of the object are identified for each of principals contained in the access control list, for example, if a new principal is added, all information about the object corresponding to the added principal has to be newly added to the list every time the principal is added. Therefore, there are problems in that, since the information provided by the conventional object supplying device lacks in general versatility, it cannot provide flexibility enough to manage changes in the information.

### SUMMARY OF THE INVENTION

In view of the above, it is an object of the present invention to provide an object supplying device which is capable of flexibly managing changes in information about an object on which an access control is exercised, in processing of the object and in permission of the processing of the object or a like.

According to a first aspect of the present invention, there is provided an object supplying device for supplying an object to one of a plurality of principals, including: a principal information storing section to store information about each of the plurality of principals; an object information storing section to store information about each of a plurality of the objects; and an application section to retrieve the object corresponding to the one principal by combining a plurality of pieces of information stored in the principal information storing section with a plurality of pieces of information stored in the object information storing section and by referring to the combined information and to supply the retrieved object to the one principal.

In the foregoing, a preferable mode is one wherein the object supplying device is a distributed processing device in a distributed processing system including a network and the distributed processing device being connected to the network.

Also, a preferable mode is one wherein the distributed processing system includes the distributed processing device operating as a server and a plurality of client units being connectable to the server through the network and wherein the principal is any one of the client units, a user using the client unit and an object contained in the client unit.

Also, a preferable mode is one wherein the distributed processing system is a portable communication system provided with a portable communication terminal and wherein the client unit constituting the principal is the portable communication terminal.

Also, a preferable mode is one that wherein includes a receiving section to receive, from the principal, information about authentication needed to authenticate one principal and an authenticating section to authenticate the one principal based on the authentication information received by the receiving section and by referring to the information stored in the principal information storing section and wherein the application section, when the one principal is authenticated by the authenticating section to be an authorized principal, performs retrieval and supply of the object.

Also, a preferable mode is one wherein the application section, when being requested by the one principal to supply an object, performs retrieval and supply of the object.

Also, a preferable mode is one that wherein includes a principal information managerial section, when information stored in the principal information managerial section is changed, notifies the change to any service requesting for notification of the change, out of two or more services and wherein the application section has a plurality of services defining a plurality of objects.

Also, a preferable mode is one that wherein includes an object information managerial section to change the object information in accordance with notification of the change from the principal information managerial section.

Furthermore, a preferable mode is one wherein combination of the information stored in the principal information storing section with the information stored in the object information storing section is defined by a predetermined matching rule.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram of configurations of a distributed processing system containing an object supplying device of the present invention according to one embodiment;

FIG. 2 is a schematic functional block diagram showing management and operation of information about the principal and object according to the embodiment of the present invention;

FIG. 3 is a diagram showing commands defining operations of a managerial section of a principal information managerial section according to the embodiment of the present invention;

FIG. 4 is a diagram showing commands defining operations of a managerial section of an object information managerial section according to the embodiment of the present invention;

FIG. 5 is a flowchart explaining operations of the distributed processing system according to the embodiment of the present invention;

FIG. 6 is a diagram showing information about a principal stored in the principal information managerial section according to the embodiment of the present invention;

FIG. 7 is a diagram showing information about an object stored in the object information managerial section according to the embodiment of the present invention;

FIG. 8 is a flowchart explaining operations of notification of changes in principal information to a service according to the embodiment of the present invention; and

FIG. 9 is a table used for management of event listeners.

### DESCRIPTION OF THE PREFERRED EMBODIMENTS

Best modes of carrying out the present invention will be described in further detail using various embodiments with reference to the accompanying drawings.

### Embodiment

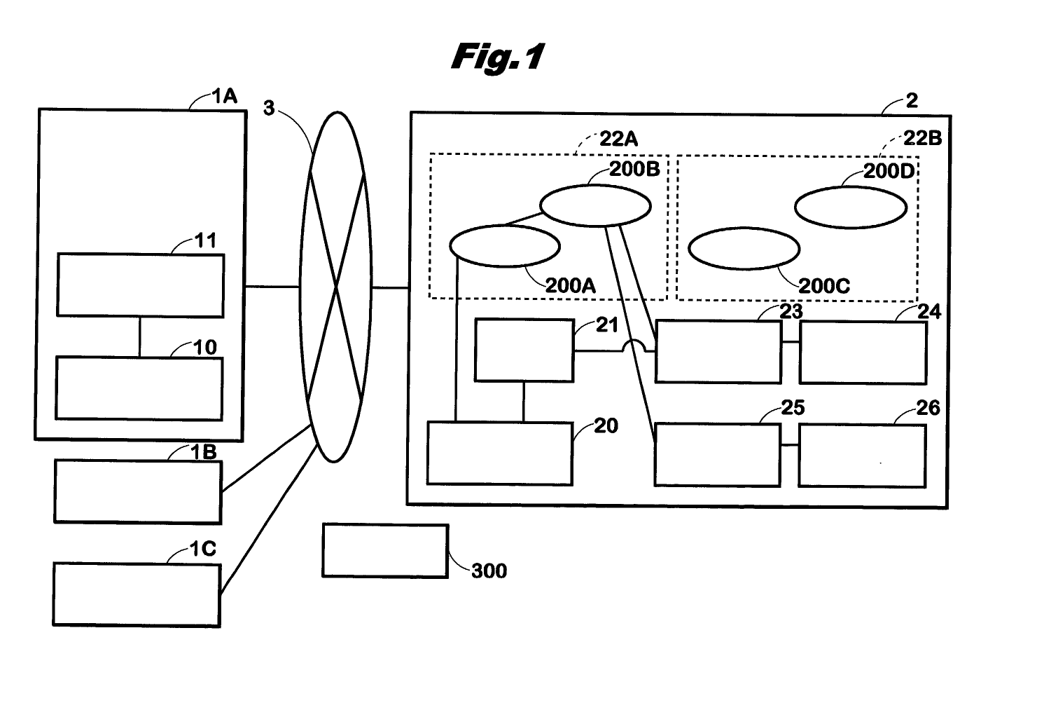

FIG. 1 is a schematic block diagram of configurations of a distributed processing system containing an object supplying device of the present invention according to one embodiment. The distributed processing system of the embodiment, as shown in FIG. 1, includes a plurality of client units 1A to 1C, an object supplying device 2 and a network 3 used to connect these client units 1A to 1C and the object supplying device 2 to each other. In the distributed processing system of the embodiment, the object supplying device 2 serves as a server to supply the object to the client units 1A to 1C through the network 3.

The client unit 1A transmits a request message 300 requesting for supply of an object to the object supplying device 2 to request the object supplying device 2 to supply the object to the client unit 1A. In response to the request message 300 from the client unit 1A, the object supplying device 2 supplies the object to the client unit 1A.

To implement these functions, each of the client units 1A to 1C is provided with a network communication controlling section 10 and a client application section 11. On the other hand, the object supplying device 2 is provided with a network communication controlling section 20, a user authenticating section 21, an application section 22A, an application section 22B, a principal information managerial section 23, a principal information managerial interfacing section 24, an object information managerial section 25 and an object information control interfacing section 26.

The network communication controlling section 10 in each of the client units 1A to 1C, to receive the object from the object supplying device 2 carries out communication with the network communication controlling section 20 in the object supplying device 2. The client application section 11 is controlled by the user of the client units 1A to 1C to receive the object.

The network communication controlling section 20 in the object supplying device 2 carries out communication with each of the client units 1A to 1C, for example, to receive the request message 300 from the client unit 1A. The user authenticating section 21 authenticates the user by comparing data for authentication contained in the request message 300 with another data for authentication registered in advance in the principal information managerial section 23.

The application sections 22A and 22B contain a plurality of services 200A, 200B, 200C and 200D defining the object or the supply of the object. Each of the application sections 22A and 22B independently accesses the principal information managerial section 23 adapted to manage information about the principal and the object information managerial section 25 adapted to manage information about the object.

The principal information managerial section 23 manages information about the principal. Specifically, the principal information managerial section 23 has the principal information managerial interfacing section 24 to perform registration, deletion and reference of the principal and setting, acquiring, deletion, reference or a like of the principal information.

The object information managerial section 25 manages the object being processing, data and/or distributing matters and the information about the object. Specifically, the object information managerial section 25 stores the object or controls corresponding relations between the principal and the object which are used to control the access to the object or processing of the object. To perform the above management, the object information managerial section 25 has the object information control interfacing section 26.

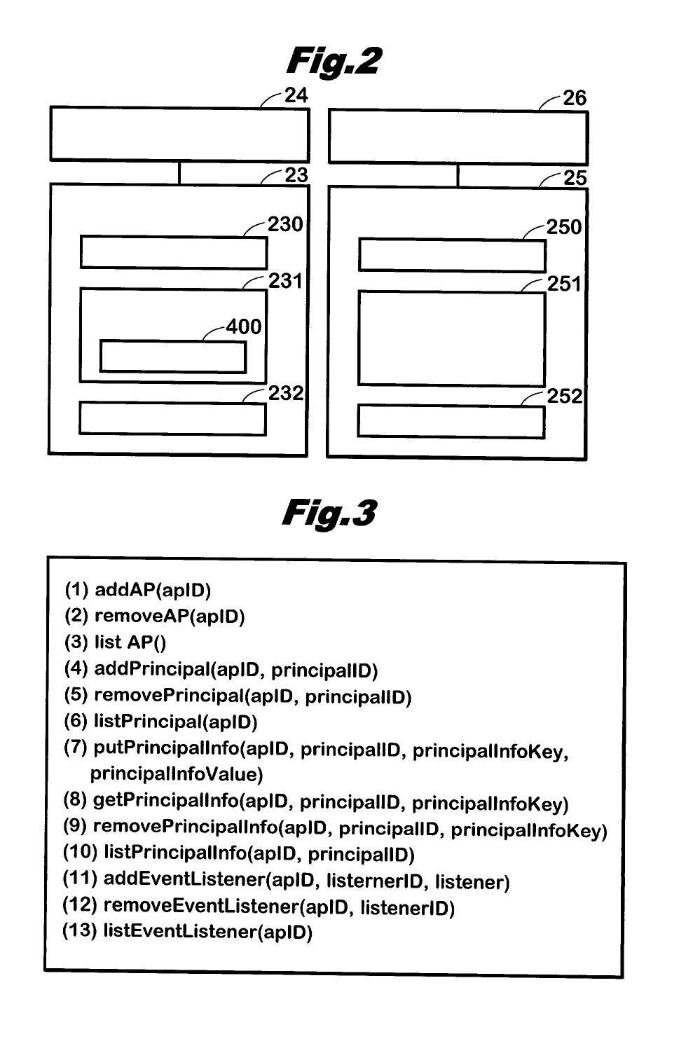

FIG. 2 is a schematic functional block diagram showing management and operation of information about the principal and object according to the embodiment. As shown in FIG. 2, the principal information managerial section 23 includes an AP (Application) section 230, a managerial section 231 and a storing section 232. The object information managerial section 25 also includes an AP section 250, a managerial section 251 and a storing section 252.

The operations of the AP sections 230 and 250 positioned in an upper layer, since the information about the principal and object is defined by each of the application sections 22A and 22B, depend on those of the application sections 22A and 22B. On the other hand, the storing section 232 positioned in a lower layer stores the principal information and the storing section 252 positioned in the lower layer stores the object information.

The managerial sections 231 and 251 positioned in an intermediate layer, since their operations do not depend on those of the application sections 22A and 22B, are commonly used by the application sections 22A and 22B. The managerial section 231, as needs come up, registers services 200A to 200D as an event listener and stores a table 400 used to manage the event listener and to notify the occurrence of the registered service event, for example, an event of changes in information about the principal.

FIG. 3 is a diagram showing commands defining operations of the managerial section 231 of the principal information managerial section 23 according to the embodiment. The managerial section 231 is fed with each of the commands shown in FIG. 3 by the principal information managerial interfacing section 24 and performs processing of the fed commands. For example, “addAP” represents addition of the application section 22, “removeAP” represents removal of the application section 22, “listAP” represents listing of the application section 22, “addPrincipal” represents addition of the principal, “removePrincipal” represents removal of the principal, “listPrincipal” represents listing of the principal, “putPrincipalInfo” represents addition of the principal information, “getPrincipalInfo” represents acquisition of the principal information, “removePrincipalInfo” represents removal of the principal information, “listPrincipalInfo” represents listing of the principal information, “addEventListener” represents addition of listeners to receive events at a time of changes in the principal information, “removeEventListener” represents removal of the listener and “listEventListener” represents listing of the listeners.

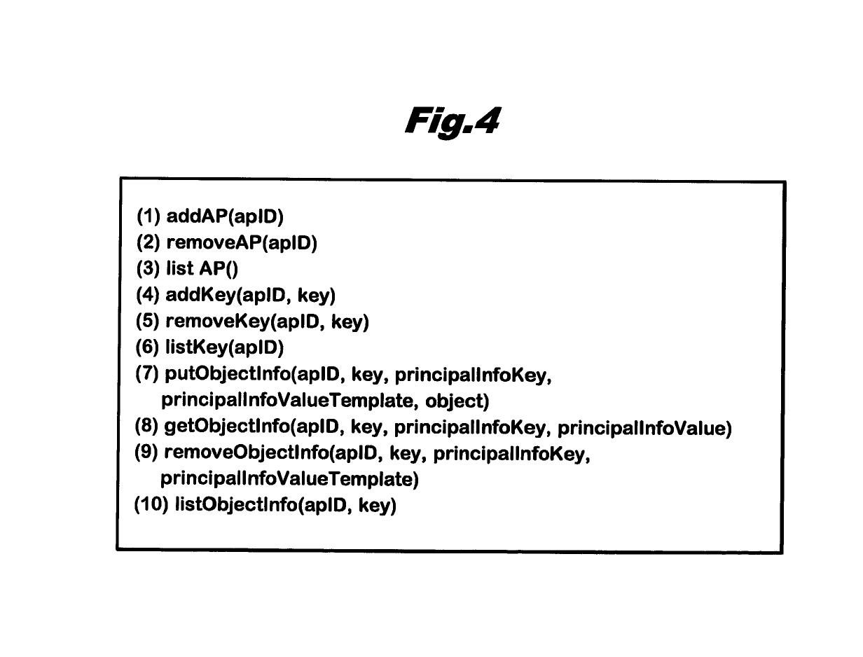

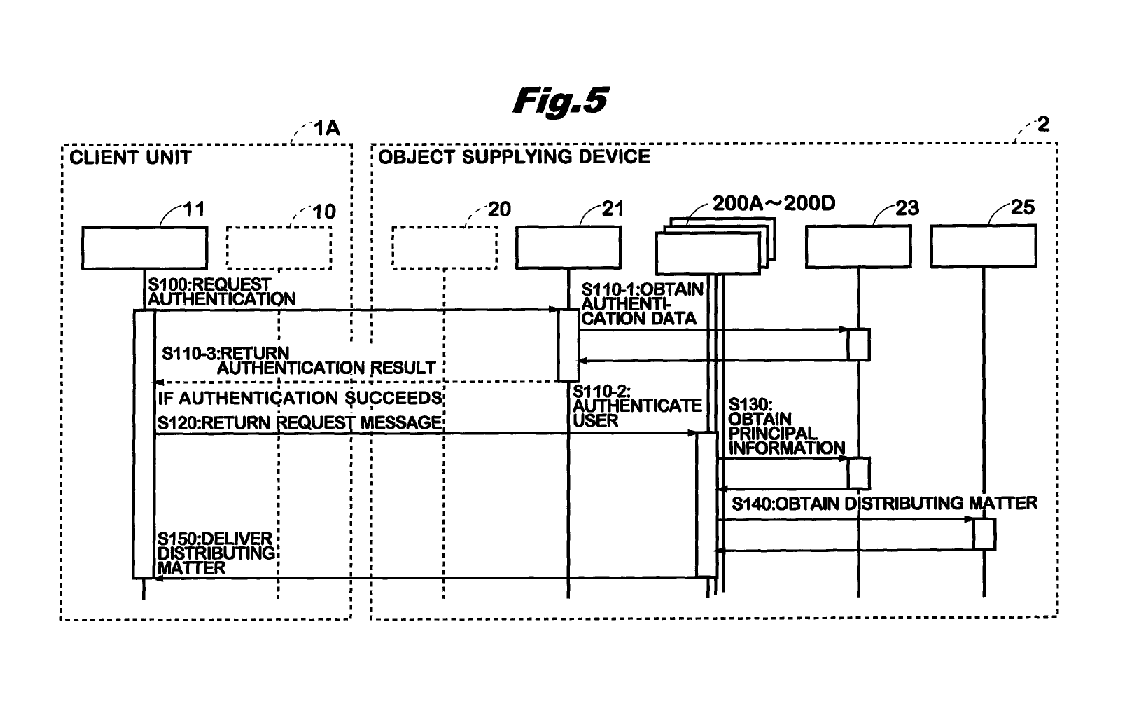

FIG. 4 is a diagram showing commands defining operations of the managerial section 251 of the object information managerial section 25 according to the embodiment of the present invention. The managerial section 251 is fed with each of the commands shown in FIG. 4 by the object information managerial interfacing section 26 and performs processing of the fed commands. Specifically, “addAP” represents addition of the application section 22, “removalAP” represents removal of the application section 22, “listAP” represents listing of the application section 22, “addKey” represent addition of the key, “removalKey” represents removal of the key, “listKey” represents listing of the key, “putObjectInfo” represents addition of the object information, “getObjectInfo” represents acquisition of the object information, “removeObjectInfo” represents removal of the object information, “listObjectInfo” represents listing of the object information. The “principalInfoValueTemplate” represents a matching rule used to obtain an object corresponding to the principal, which is adapted to associate the information about the principal with the information about the object, for example, to define operations to derive, using the information about the principal, the object corresponding to the principal.

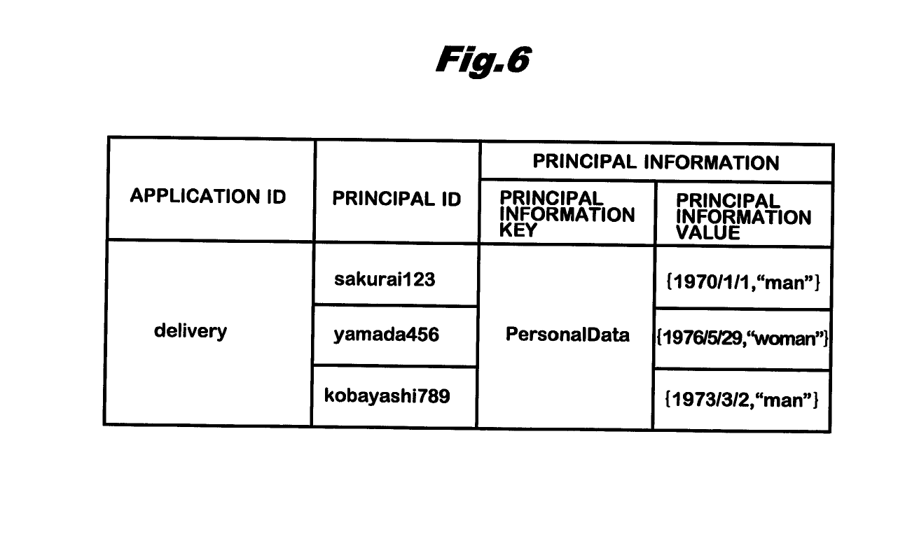

FIG. 6 is a diagram showing information about the principal stored in the principal information managerial section 23. As shown in FIG. 6, the principal information managerial section 23 stores an application ID, a principal ID and information about each of a plurality of principals. The principal information is made up of a principal information key and a principal information value. Specifically, the principal information managerial section 23 stores “delivery” as the application ID, “sakurai 123” as the principal ID, “PeronalData” as the principal information key, “{1970/1/1, “man”}” as the principal information value.

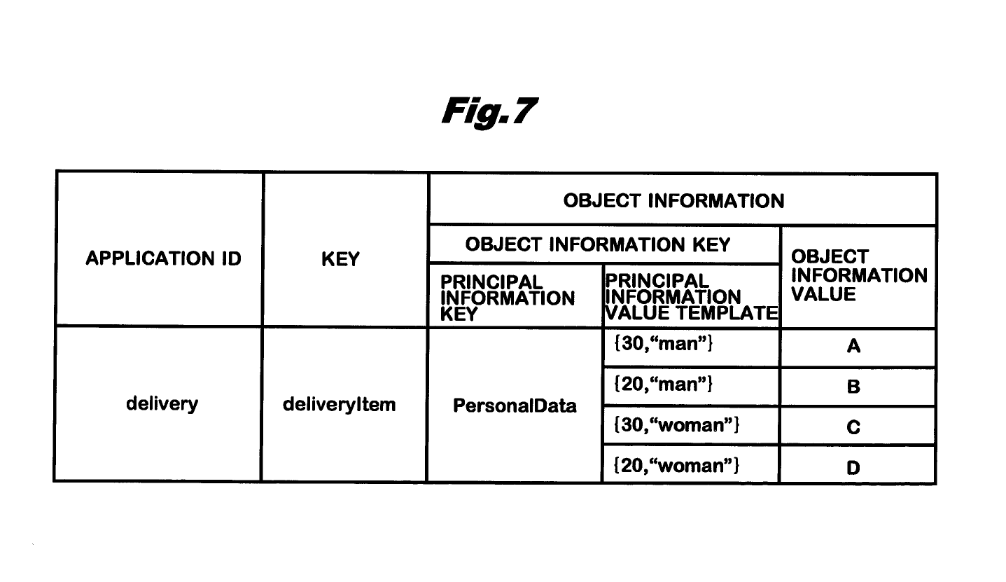

FIG. 7 is a diagram showing information about the object stored in the object information managerial section 25. As shown in FIG. 7, the object information managerial section 25 stores an application ID, a key and information about each of a plurality of objects. The object information is made up of an object information key and an object information value. The object information key is made up of a principal information key and a principal information value template.

The object information managerial section 25 stores, for example, “delivery” as the application ID, “deliveryItem” as the key, “PersonalData” as the principal information key, “{30, “man”}” to “{20, “woman”}” as the principal information value template, “A” to “D” as the object information value. The principal information key “PersonalData” includes the matching rule, as described above, used when the object corresponding to the principal is obtained. By using the matching rule, for example, a difference between a today's date and a date of birth, that is, an age is calculated. The calculated age is used when retrieval is performed using the principal information value template.

Each part of the object supplying device 2 is operated to function independently to supply the object, that is, to function as the distributed processing system.

FIG. 5 is a flowchart explaining operations of the distributed processing system according to the embodiment. To facilitate explanations and understanding of the operations, an example is shown in which an user of the client unit 1A receives a distributing matter corresponding to the age and the distinction of sex from the object supplying device 2.

Step S100: The user, since user authentication is required to receive a service from the object supplying device 2, performs operations to obtain the authentication from the client application section 11 in the client unit 1A, for example, logging-in process. When the logging-in has completed, the client application section 11 sends out a request for authentication to the object supplying device 2. A user ID, authentication data such as a password and a related command are included in the request for authentication.

Step S110: In the object supplying device 2, the network communication controlling section 20 receives the request for authentication and transfers it to the user authenticating section 21. The user authenticating section 21 reads data required for the user authentication from the principal information managerial section 23 and performs the authentication by comparing the read data with that for the authentication contained in the received request. The user authenticating section 21 returns a result of the authentication to the client application section 11 in the client unit 1A.

Step S120: When the user is authenticated to be an authorized person, in the client unit 1A, the client application section 11 transmits, in accordance with instructions of the user, a request message 300 for receiving services 200A to 200D that the object supplying device 2 supplies, that is, for obtaining objects, to the object supplying unit 2. The request message 300 contains a principal ID and a related command. In the example, the principal ID is “sakurai123”. If the user is not authenticated to be an authorized person, the client application section 11 terminates the processing.

Step S130: The service 200A, by referring to information about the principal, as shown in FIG. 6, stored in the principal information managerial section 23, based on the principal ID contained in the request message 300, obtains a key and a value corresponding to the principal ID contained in the request message 300. Specifically, the service 200A reads a principal information key “PersonalData” and a principal information value “{1970/1/1, “man”}”.

Step S140: The service 200A, by using the principal information value “{1970/1/1, “man”}” and the today's date “{2000/*/*}” and by following the matching rule contained in the principal information key “PersonalData”, that is, the age calculation rule, calculates a value “{30, “man”}” being usable as the principal information template as shown in FIG. 7. Then, the service 200A, by referring to the principal information value template and the object information value as shown in FIG. 7, obtains an object information value “A” corresponding to the above value “{30, “man”}”, that is, the distributing matter “A”.

Step S150: The service 200A, after having obtained the distributing matter in Step S140, sends out the distributing matter “A” to the client unit 1A. Thus, based on the principal ID “sakurai 123” contained in the request message 300 of the user of the client unit 1A, the principal information key “PersonalData” and the principal information value “{1970/1/1, “man”}” in the information about the principal as shown in FIG. 6 are selected and, further, based on the selected principal information key and principal information value, the object “A” contained in the information about the object as shown in FIG. 7, that is, the distributing matter “A” is identified and the identified distributing matter “A” is supplied to the client unit 1A of the user of the principal ID “sakurai 123” from the object supplying device 2.

Thus, in the object supplying device of the embodiment of the present invention, as described above, since the management of supply of objects by the services 200A to 200D is performed by combining the information about principals as shown in FIG. 6 with the information about objects as shown in FIG. 7, it is made possible to provide generality and versatility to the information required for supplying the object, that is, it becomes possible to eliminate such complicated procedures as detailed definition of the information about the object for each principal. Moreover, since the information about the principal and about the object is managed in a more unified way, it is also possible for a plurality of services 200A to 200D to share information about the principal and the object.

That is, according to the object supplying device of the present invention, control on the principal's access to the object is performed by combining the information about a plurality of principals with the information about a plurality of objects and by referring to the combined information. For example, in the case of objects that can be commonly applied to two or more principals, all the principals can share the information about objects and, therefore, it is not necessary to describe the information about the object being commonly used among principals using the list in a duplicated manner, unlike the conventional case, thus preventing redundancy in terms of procedures and enabling effective management of the information about both the principals and objects.

Moreover, for example, in the case of addition of a new principal, new addition of the information about all the object corresponding to the new principal to be added is not required and, by adding only information about the object that differs from those already stored, the addition can be achieved, thus enabling effective use of the information in a managed manner and providing general versatility to access management for supply of the object.

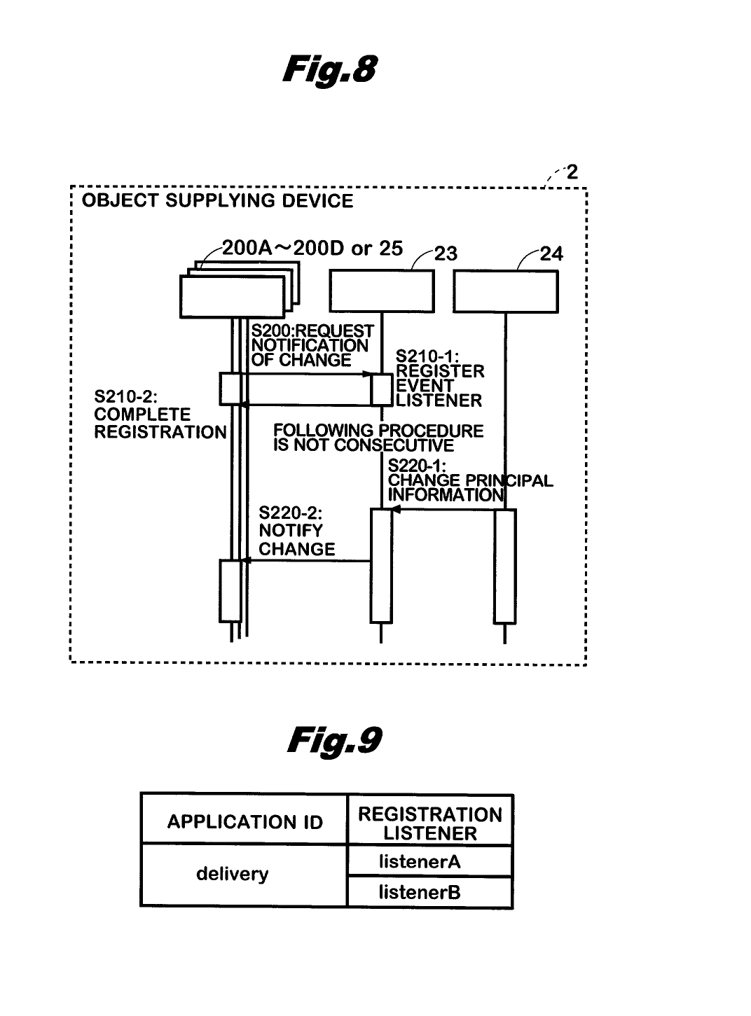

FIG. 8 is a flowchart explaining operations of notification of changes in the principal information to the service according to the embodiment of the present invention. To facilitate explanations and understanding of the operations, in the example, let it be assumed that it is desired that, when the principal information key “PersonalData” goes out of use and when the principal information key being associated with the service 200A and 200B is changed, an event informing of the above states is notified to the service 200A and 200B by the principal information managerial section 23. To cause the principal information key to go out of use, a manager of the application section 22 controls the principal information managerial interfacing section 24 to delete the principal information key “PersonalData” from the principal information managerial section 23.

Step S200: The services 200A and 200B, when changes in the principal information occur, requires the principal information managerial section 23 to notify the change to the services 200A and 200B.

Step S210: The principal information managerial section 23, when receiving the request for notification of changes in the principal information, registers the services 200A and 200B as event listeners on the table 400 shown in FIG. 2. As a result, the principal information managerial section 23 waits for changes in the principal information.

FIG. 9 is a table used for management of event listeners. As shown in FIG. 9, an application ID “delivery” and a registration listener “listener A” are registered for the service A, while the application ID “delivery” and a registration listener “listener B” are registered for the service B.

Step S220: When the principal information key “PersonalData” is deleted by the manipulation of the above manager from the principal information managerial section 23, the principal information managerial section 23 notifies the deletion to the event listeners A and B, services 200A and 200B and the object information managerial section 25. This causes the services 200A and 200B and the object information managerial section 25 to recognize the deletion of the principal information key “PersonalData”. The services 200A and 200B, in accordance with the above deletion, takes necessary procedures, for example, for changing setting of the object to be controlled or to be monitored. The object information managerial section 25 also deletes data associated with the principal information key “PersonalData”, in accordance with the predetermined procedures.

Thus, according to the object supplying device of the embodiment of the present invention, as described above, since changes in the principal information are notified to the services 200A and 200B being associated with the principal information, it is possible that changes in the principal information can be reflected immediately in the services 200A and 200B, that is, in objects defined by the services 200A and 200B.

As described above, with the configurations of the present invention, since an object corresponding to one principal is retrieved and the retrieved object is supplied to the above one principal by combining the information about a plurality of principals with the information about a plurality of objects and by referring to the combined information, general versatility is provided to the management of supply of objects, unlike in the conventional case in which the list used to control the principal's access to the object is simply referred to.

It is thus apparent that the present invention is not limited to the above embodiments but may be changed and modified without departing from the scope and spirit of the invention.

What is claimed is:

1. An object supplying device for supplying an object to one of a plurality of principals, comprising:
a principal information storing section to store information about each of said plurality of principals;
an object information storing section to store information about each of a plurality of said objects; and
an application section to retrieve said object corresponding to said one principal by combining a plurality of pieces of information stored in said principal information storing section with a plurality of pieces of information stored in said object information storing section and by referring to said combined information and to supply said retrieved object to said one principal.

2. The object supplying device according to claim 1, wherein said object supplying device is a distributed processing device in a distributed processing system including a network and said distributed processing device being connected to said network.

3. The object supplying device according to claim 2, wherein said distributed processing system includes said distributed processing device operating as a server and a plurality of client units being connectable to said server through said network and wherein said principal is any one of said client units, a user using said client unit and an object contained in said client unit.

4. The object supplying device according to claim 3, wherein said distributed processing system is a portable communication system provided with a portable communication terminal and wherein said client unit constituting said principal is said portable communication terminal.

5. The object supplying device according to claim 1, further comprising a receiving section to receive, from said principal, information about authentication needed to authenticate one principal and an authenticating section to authenticate said one principal based on said authentication information received by said receiving section and by referring to said information stored in said principal information storing section and wherein said application section, when said one principal is authenticated by said authenticating section to be an authorized principal, performs retrieval and supply of said object.

6. The object supplying device according to claim 1, said application section, when being requested by said one principal to supply an object, performs retrieval and supply of said object.

7. The object supplying device according to claim 1, further comprising a principal information managerial section, when information stored in said principal information managerial section is changed, notifies said change to any service requesting for notification of said change, out of two or more services and wherein said application section has a plurality of services defining a plurality of objects.

8. The object supplying device according to claim 7, further comprising an object information managerial section to change said object information in accordance with notification of said change from said principal information managerial section.

9. The object supplying device according to claim 1, wherein combination of said information stored in said principal information storing section with said information stored in said object information storing section is defined by a predetermined matching rule.
